(19) United States
(12) Patent Application Publication
(10) Pub. No.: US 2010/0024158 A1
(43) Pub. Date: Feb. 4, 2010

(54) Regulating Valve

(75) Inventor: Bernd Winkler, Breckerfeld (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 12/531,639

(22) PCT Filed: Feb. 28, 2008
(86) PCT No.: PCT/EP08/01572

§ 371 Date: Sep. 16, 2009

(30) Foreign Application Priority Data
Mar. 16, 2007 (DE) 20 2007 004 104.7

(51) Int. Cl. E05F 3/04; F16K 1/50

(52) U.S. Cl. 16/51; 251/366

(57) ABSTRACT

A regulating valve, which in particular is attachable in a bore of a hydraulic door closer formed with a female thread. The valve has a body, having an anti-rotation protection and a thread, which can be disposed in the female thread of the bore. A regulating area is attached to the body. The anti-rotation protection has at least one groove, which is disposed at the thread and accommodates an elastic element.

The invention relates to a regulating valve, which in particular is attachable in a bore of a hydraulic door closer executed with a female thread, which valve has a body with a regulating area, an anti-rotation protection, and a thread, which can be disposed in the female thread of the bore.

DE 102 28 872 B4 discloses a regulating valve for a door closer, which consists of a body and a regulating area. For regulating the regulating valve, the body has a thread that is screwable into a bore of the door closer. In this case, the regulating area is executed in a bush-shape and connected to the body via a ball-joint connection. In order to avoid any unwanted rotation of the regulating valve, in particular of the regulating area, an anti-rotation protection is provided, which is disposed at the regulating area and is formed as an extension or as a projection. This extension is longitudinally movable and guided in a groove within the housing of the door closer.

It is the object of the present invention to provide a regulating valve of the species described in the introduction, which has a simple design, any unwanted adjustment of the regulating valve during operation being excluded.

As the solution to this problem, a regulating valve is proposed having the features of patent claim 1. Preferred further developments are set forth in the dependent patent claims.

According to the invention, it is intended that the anti-rotation protection has at least one groove, which is disposed at the thread and receives an elastic element, the body, at the side oriented towards the valve seat, having a hollow space, into which the regulating area extends, and the regulating area being attached to the body. The regulating valve is screwed into the door closer, the closing behavior of the door closer being able to be adjusted at the regulating valve. On account of the anti-rotation protection, the inventive regulating valve has a reliable seat without any independent rotating or adjusting of the regulating valve occurring. For realizing a corresponding closing behavior of the door closer, damping fluid is generally used, which is guided along flow channels. By means of an appropriate adjusting at the regulating valve, at least at one location, the flow cross-section can be modified for the fluid, whereby the closing behavior, and in particular the closing speed of the door closer can be regulated. Despite the forces, which are originated by the flowing fluid acting upon the regulating valve, the anti-rotation protection ensures that the regulating valve does not readjust accidentally and independently. If the regulating valve is in the screwed-in condition, the elastic element is located within the groove and directly bears against the female thread of the bore of the door closer, thus achieving a clamping effect. This means that the play between the female thread of the bore and the thread of the regulating valve is completely filled by the elastic element. This generates a high surface pressure, in particular between the thread flanks of the female thread and of the regulating valve. It has been shown that, due to such a disposition, the engaging thread parts no longer rotate independently. Furthermore, a manual and/or intentional adjusting of the regulating valve is obviously still possible. In other words this means that the regulating valve can be adjusted corresponding to the specific requirements of a defined closing behavior at any time, the anti-rotation protection effectively avoiding independent rotation, in particular the one caused by occurring dynamic stress.

In one possible embodiment of the invention, the elastic element is disposed in the groove positively and/or non-positively and/or positively through a material. Advantageously, the elastic element is pressed into the groove without any risk of disengaging from the groove during the mounting operation and/or the adjusting operation of the regulating valve. This anti-rotation protection, which is disposed at the thread, represents an inexpensive option of reliably counteracting any independent loosening and releasing of the regulating valve from the thread. In this case, the thread may be a buttress thread, a trapezoidal thread, a round thread or a flat thread. Preferably, the groove extends parallel towards the axis of rotation of the regulating valve. Furthermore, there is the option that the groove extends along the entire thread of the regulating valve. In another alternative, the regulating valve may be embodied with several grooves at the thread, which are for example circumferentially offset by 180° or 120° with regard to each other. However, in particular with hydraulic door closers, it has proven to be sufficient having only a single groove and one elastic element as a reliable functioning anti-rotation protection.

In an alternative embodiment of the invention, the regulating area has a free end, which faces away from the body and is conically shaped. In addition, the door closer may have a supply channel, a drainage channel and a conically shaped valve seat, a damping fluid being able to be conducted through the supply channel along the valve seat and to the drainage channel. The free end of the regulating area is substantially adapted to the valve seat of the door closer. As a rule, there is a certain distance between the valve seat and the conically shaped end of the regulating area, such that the fluid can flow from the supply channel between the valve seat and the conically shaped end of the regulating area in the direction of the drainage channel.

In one possible alternative of the regulating valve, the body and the regulating area are formed in one piece and from the same material. Furthermore, it is obviously conceivable to manufacture the body and the regulating area from two different materials. In the last-mentioned embodiment alternative, the regulating area is disposed at the body in particular by means of an injection moulding process. The body may be made from metal, for example, zinc, brass or steel, the regulating area being preferably made from plastic material. In order to achieve a high strength in particular, the plastic material may be reinforced by fibres, in particular, the plastic material may have a certain percentage of fibre glass and/or carbon fibres and/or aramid fibres. Obviously, the body may be manufactured from plastic material. Through forming the regulating area from a plastic material, it has been proven that the closing behavior of the door closer—even under changing temperatures—remains substantially unchanged. In another alternative, a body made from plastic material may be easily provided with some color, such as to easily distinguish the different types of regulating valves visually. Advantageously, the body and the regulating area are interconnected through a two component injection moulding process. In a possible alternative, it might be practical to introduce the elastic element, as an injection moulding part made from plastic material, into the groove.

In order to guarantee a reliable support of the regulating area at the body, at the side oriented towards the valve seat, the body has a hollow space, into which the regulating area extends. In this case, the body may be executed with at least one opening at the hollow space, which opening is filled by the regulating area. Thus, the regulating area likewise extends into the opening of the body, whereby the fastening of the regulating area at the body is additionally reinforced.

In a preferred embodiment of the regulating valve it is intended that the thread, which may be formed at the body or likewise at the regulating area, has a nominal diameter D and a core diameter d, the groove being executed with a groove depth value, which is in particular between the core diameter d and the nominal diameter D. In the mounted condition of the regulating valve, the elastic element fills the interspace between the female thread of the door closer and the thread of the regulating valve, whereby a higher surface pressure can be achieved at the engaging thread parts.

The elastic element may be a plastic material strand, which, for example, is pressed into the groove. Conveniently, the groove is machined into the thread through milling and goes up to just about to the core diameter. In an alternative of the invention, the plastic material strand is formed as a nylon strand.

Further advantages, features and details of the invention will result from the following description, in which exemplary embodiments of the invention are described in detail, reference being made to the drawings. In this case, the features mentioned in the patent claims and in the description, may be individually or in random combination essential to the invention.

The drawings show:

FIG. 1: an inventive regulating valve including an anti-rotation protection, which has a groove as well as an elastic element,

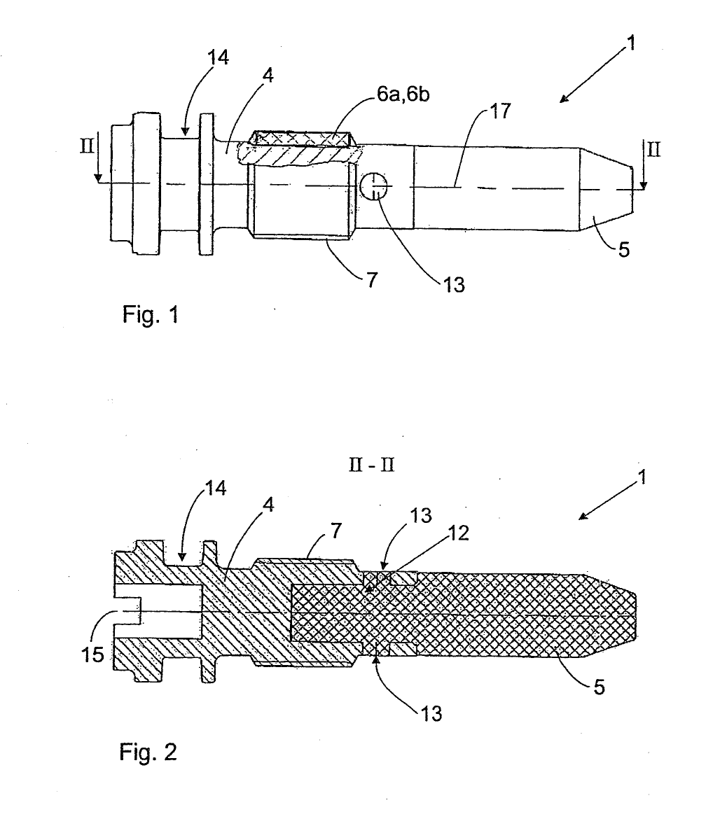

FIG. 2: the regulating valve of FIG. 1 along the section line II-II,

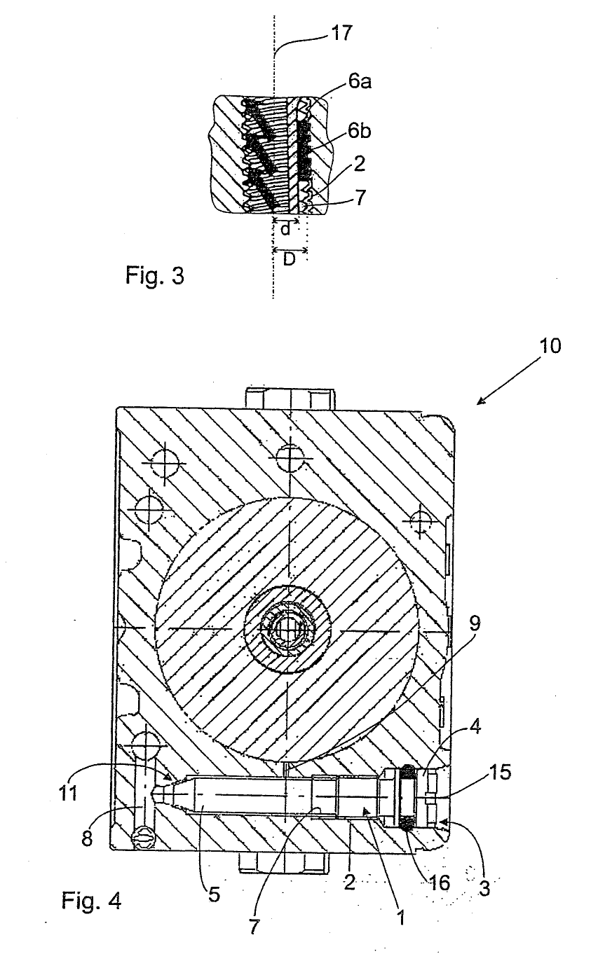

FIG. 3: an enlarged illustration of the elastic element within the groove, and

FIG. 4: the inventive regulating valve in the installed condition within a hydraulic door closer.

FIG. 1 shows a regulating valve 1, which is provided for a hydraulic door closer. In this case, various door closers can be considered, which for example can be operated by an eccentric cam disc according to DE 103 61 085 A1 or by a toothed rack according to DE 199 01 234 C1. The regulating valve 1 is formed with a body 4, which, in the illustrated exemplary embodiment, is made from metal. A slot 15, illustrated in FIG. 2, is formed in the head area of the body 4. It is by means of this slot 15, that the mechanic can screw the regulating valve 1 into a bore 3 of the door closer 10, which is illustrated in FIG. 4, and can adjust the closing behavior of the door closer 10 accordingly. Furthermore, the body 4 is equipped with a thread 7, which cooperates with a female thread 2 of the door closer 10. The thread 7 is formed as a fine thread having an anti-rotation protection, which consists of a groove 6a and an elastic element 6b. According to FIG. 1, the groove 6a extends along the entire thread 7 parallel with regard to the axis of rotation 17 of the regulating valve 1. Obviously, the groove 6a may extend only over a partial area of the thread 7, which is illustrated in an enlarged illustration according to FIG. 3.

In addition, the regulating valve 1 has a regulating area 5 which is disposed at the body 4 through an injection moulding process. The regulating area 5 consists of plastic material, which in the present exemplary embodiment is polyoxymethylene (POM), distinguished among others by its good electrical feature, good chemical resistance and a high abrasion resistance. At its free end, facing away from the body 4, the regulating area 5 is executed in a tapering cone-shaped manner.

The metal body 4, at the side facing away from the slot 15, has a hollow space 12 into which the regulating area 5 completely extends. In addition, two circular openings 13, which are likewise filled by the regulating area 5, are disposed at the hollow space 12. A reception 14 for a sealing element 16, which is explicitly shown in FIG. 4, is provided between the thread 7 and the slot 15.

In FIG. 3, the thread 7 has a nominal diameter D and a core diameter d, the groove 6a, which is milled into the thread 7 has a groove depth value, which is between the core diameter d and the nominal diameter D. When screwing the regulating valve 1 into the bore 3, an additional clamping effect is achieved by the inventive anti-rotation protection 6a, 6b. As in particular revealed by FIG. 3, the axial play between the thread 7 of the regulating valve 1 and the female thread 2 of the bore 3 is filled by the elastic element 6b. Thereby, a high surface pressure is achieved at the thread parts 2, 7 engaging each other, in particular at the thread flanks which are free from the anti-rotation means, which is indicated through the illustrated arrows in FIG. 3. The elastic element 6b, which is pressed into the groove 6a, is a plastic material strand 6b. The particular advantage of the described anti-rotation protection 6a, 6b is that it will reliably avoid independent misadjustment of the regulating valve 1. At the same time, the regulating valve 1 can be manually adjusted and/or unscrewed from the bore 3 at any time.

According to FIG. 4, the free end of the regulating area 5 is located within a conically shaped valve seat 11 of the door closer 10. A supply channel 8, through which oil is conducted, is located in the region of the conically shaped end of the regulating area 5. Generally, the conically shaped end of the regulating area 5 does not directly bear against the valve seat 11, such that the oil can flow through the small channel, formed between the valve seat 11 and the conically shaped free end of the regulating area 5, in the direction of a drainage channel 9. The flow cross-section for the oil can be adjusted at the regulating valve 1, whereby in particular the closing behavior of the door closer 10 is controllable. On account of the above described anti-rotation protection 6a, 6b, the forces, produced by the flowing oil and acting upon the regulating valve 1, are unable to cause any unwanted rotation of the regulating valve 1, not even in the tolerance range.

### LIST OF REFERENCE NUMERALS

1 regulating valve
2 female thread
3 bore
4 body
5 regulating area
6a groove
6b elastic element
7 thread
8 supply channel
9 drainage channel
10 door closer
11 valve seat
12 hollow space
13 opening
14 reception for a sealing
15 slot
16 sealing
17 axis of rotation of the regulating valve

1.-11. (canceled)

12. A regulating valve attachable in a bore, wherein the bore is formed in a hydraulic door closer and has a female thread and a valve seat, the regulating valve comprising:
a body with an anti-rotation protection and a thread engageable with the female thread of the bore; and
a regulating area attached to the body;
wherein the anti-rotation protection has at least one groove disposed at the thread and an elastic element received in the at least one groove; and
wherein the body, at a side oriented towards the valve seat when the regulating valve is attached in the bore of the door closer, has a hollow space into which the regulating area extends.

13. The regulating valve according to claim 12, wherein the elastic element is disposed one of positively, non-positively, and positively through a material in the groove.

14. The regulating valve according to claim 12, wherein the regulating area has a free end facing away from the body and being conically shaped.

15. The regulating valve according to claim 12, wherein the regulating area is attached to the body through an injection moulding process.

16. The regulating valve according to claim 12, wherein at least one of the body and the regulating area comprises a plastic material.

17. The regulating valve according to claim 12, wherein the body is colored to indicate a type of the regulating valve.

18. The regulating valve according to claim 12, wherein the thread has a nominal diameter D and a core diameter d, the groove having a groove depth value, which is between the core diameter d and the nominal diameter D.

19. The regulating valve according to claim 12, wherein the elastic element is a plastic material strand.

20. The regulating valve according to claim 12, further comprising the door closer, wherein the door closer presents a supply channel, a drainage channel and a conically shaped valve seat, whereby a fluid can be conducted through the supply channel along the valve seat to the drainage channel.

21. The regulating valve according to claim 20, wherein the body has at least one opening at the hollow space, and the opening is filled by the regulating area.

22. The regulating valve according to claim 20, wherein the door closer is formed with a bore having a female thread and a valve seat.

23. The regulating valve according to claim 12, wherein the elastic element is an injection molded part made from a plastic material.

24. The regulating valve according to claim 13, wherein the regulating area has a free end facing away from the body and being conically shaped.

25. The regulating valve according to claim 12, wherein the body comprises a fiber reinforced plastic material.

26. A door closer comprising:
a supply channel;
a drainage channel;
a bore having a female thread and a conically shaped valve seat; and
a regulating valve attachable in the bore, the regulating valve comprising:
a body with an anti-rotation protection and a thread engageable with the female thread of the bore; and
a regulating area attachable to the body;
wherein the anti-rotation protection has at least one groove disposed at the thread and an elastic element received in the at least one groove; and
wherein the body, at a side oriented towards the valve seat, has a hollow space, into which the regulating area extends;
whereby a fluid can be conducted through the supply channel along the valve seat to the drainage channel.
